(19) United States
(12) Patent Application Publication
(10) Pub. No.: US 2015/0131036 A1
(43) Pub. Date: May 14, 2015

(54) LIQUID CRYSTAL DISPLAY

(71) Applicant: Samsung Display Co., Ltd., Yongin-City (KR)

(72) Inventors: SEUNG JUN YU, Suwonsi (KR); Sang-Myoung LEE, Seoul (KR); JUNSEOK LEE, Seoul (KR); YOUNGGOO SONG, Asan-si (KR); Sang Woo WHANGBO, Seoul (KR)

(73) Assignee: Samsung Display Co., Ltd., Yongin-City (KR)

(21) Appl. No.: 14/244,718

(22) Filed: Apr. 3, 2014

(30) Foreign Application Priority Data
Nov. 11, 2013 (KR) 10-2013-0136408

(51) Int. Cl. G02F 1/1335; G02F 1/1343

(52) U.S. Cl. CPC G02F 1/133528; G02F 1/13439
USPC 349/96

(57) ABSTRACT

A liquid crystal display includes a first polarizing plate that includes a plurality of first areas to polarize a light and a second area disposed between the first areas to block the light, a pixel layer that includes a plurality of pixels and receives a first polarized light, a liquid crystal layer driven by the plurality of pixels and rotating a polarizing axis of the first polarized light to convert the first polarized light to a second polarized light having a polarizing axis substantially vertical to the polarizing axis of the first polarized light, and a second polarizing plate that transmits the second polarized light.

### CROSS-REFERENCE TO RELATED APPLICATION

This U.S. non-provisional patent application claims priority under 35 U.S.C. §119 to Korean Patent Application No. 10-2013-0136408 filed on Nov. 11, 2013, the contents of which are hereby incorporated by reference in its entirety.

### BACKGROUND

1. Field of Disclosure

The present disclosure relates to a liquid crystal display capable of reducing thickness thereof and improving reliability thereof.

2. Description of the Related Art

In general, a liquid crystal display includes a liquid crystal display panel including a first substrate, a second substrate facing the first substrate, and a liquid crystal layer interposed between the first substrate and the second substrate. The first substrate includes a plurality of pixel electrodes to drive the liquid crystal layer and the second substrate includes a common electrode.

An electric field is formed between the pixel electrode and the common electrode by a data voltage applied to the pixel electrodes and a common voltage applied to the common electrode. Due to the electric field formed between the common electrode and the pixel electrode, liquid crystal molecules in the liquid crystal layer are realigned and an amount of light passing through the liquid crystal layer is controlled, thereby displaying a desired image.

Polarizing plates are disposed on upper and lower portions of the liquid crystal display, respectively. The liquid crystal display receives the light from a backlight unit. The light exiting from the backlight unit is polarized and incident to the liquid crystal display panel. The liquid crystal display panel displays the image using an optical anisotropy of the liquid crystal molecules and a polarization characteristic of the polarizing plate.

### SUMMARY

The present disclosure provides a liquid crystal display capable of reducing thickness thereof and improving reliability thereof.

Embodiments of the inventive concept provide a liquid crystal display including a first polarizing plate that includes a plurality of first areas to polarize a light and a second area disposed between the first areas to block the light, a pixel layer that includes a plurality of pixels and receives a first polarized light, a liquid crystal layer driven by the plurality of pixels and rotating a polarizing axis of the first polarized light to convert the first polarized light to a second polarized light having a polarizing axis substantially vertical to the polarizing axis of the first polarized light, and a second polarizing plate that transmits the second polarized light.

The pixel layer includes a plurality of pixel areas corresponding to the first areas to receive the first polarized light and a non-pixel area disposed between the pixel areas to correspond to the second area.

The first polarizing plate includes a first electrode applied with a first voltage, a first polarizing member disposed on the first electrode, and a second electrode disposed on the first polarizing member to receive a second voltage. The light is polarized by the first polarizing member in the first areas and provided to the pixel areas as the first polarized light, and the light is blocked by the first polarizing member in the second area.

The first polarizing member includes a plurality of first polarizing patterns disposed in the first areas and extending in a first direction, a first light absorbing member disposed in the second area. The first polarizing patterns transmit the light substantially vertical to the first direction among the light as the first polarized light, and the first light absorbing member blocks the light.

The second voltage includes a positive second voltage having a level higher than a level of the first voltage and a negative second voltage having a level lower than the level of the first voltage.

The second electrode receives the positive second voltage and the first light absorbing member absorbs the light.

The second electrode receives the negative second voltage and the first light absorbing member reflects the light.

The second polarizing plate includes a third electrode applied with a third voltage, a second polarizing member disposed on the third electrode to transmit the second polarized light, and a fourth electrode disposed on the second polarizing member to receive a fourth voltage having a level higher than a level of the third voltage.

The first polarizing member and the second polarizing member includes silver nitrate (AgNO3), copper chloride (CuCl2), tetra-n-butylammonium bromide (TBABr), and vynyl butyral (PVB).

The second polarizing member includes a plurality of second polarizing patterns extending in a direction substantially vertical to the polarizing axis of the second polarized light and the second polarizing patterns transmit the second polarized light.

A pitch of the second polarizing pattern is from about 100 nm to about 200 nm.

Each of the first and second polarizing patterns has a width from about 50 nm to about 100 nm and a thickness from about 50 nm to about 100 nm.

The second polarizing plate includes a third electrode applied with a third voltage, a second polarizing member disposed on the third electrode, and a fourth electrode disposed on the second polarizing member to receive a fourth voltage having a level higher than a level of the third voltage, and the second polarizing member transmits the second polarized light in areas corresponding to the pixel areas and reflects the light and an external light in an area corresponding to the non-pixel area.

The second polarizing member includes a plurality of second polarizing patterns disposed in the areas corresponding to the pixel areas and extending in a direction substantially vertical to the polarizing axis of the second polarized light, and a second light absorbing member disposed in the area corresponding to the non-pixel area, the second polarizing patterns transmit the second polarized light and the second light absorbing member blocks the light and the external light.

The liquid crystal display further includes first and second substrates facing each other, and a backlight unit disposed under the first substrate to provide the light to the first polarizing plate. The first polarizing plate may be disposed on the first substrate and the second polarizing plate is disposed under the second substrate.

Each of the first and second polarizing plates has a thickness of about 2.3 micrometers.

Embodiments of the inventive concept provide a liquid crystal display including a first polarizing plate that includes a first polarizing plate that includes a plurality of first areas to polarize a light and a second area disposed between the first areas to block the light, the first area including a first polarizing patterns extending along a first direction, a pixel layer that includes a plurality of pixels and receives a first polarized light, a liquid crystal layer driven by the plurality of pixels and rotating a polarizing axis of the first polarized light to convert the first polarized light to a second polarized light having a polarizing axis substantially vertical to the polarizing axis of the first polarized light, and a second polarizing plate that transmits the second polarized light, the second polarizing plate including a second polarizing patterns extending along a second direction substantially perpendicular to the first direction.

The first polarizing plate is disposed on a first substrate and the second polarizing plate is disposed on a second substrate facing the first substrate. Each of the first polarizing plate and the second polarizing plate includes a first electrode, a second electrode and an electrochromic material disposed between the first electrode and the second electrode.

The first polarizing plate is disposed between a color filter layer and a pixel electrode.

The first polarizing patterns and the second polarizing patterns have a width and a height, and the height is greater than the width.

According to the above, the thickness of the liquid crystal display may be reduced and the display reliability of the liquid crystal display may be improved.

### BRIEF DESCRIPTION OF THE DRAWINGS

The above and other advantages of the present disclosure will become readily apparent with reference to the following detailed description when considered in conjunction with the accompanying drawings wherein:

FIG. 1 is a plan view showing a liquid crystal display according to an exemplary embodiment of the present disclosure;

FIG. 2 is an exploded perspective view showing a display panel shown in FIG. 1;

FIG. 3 is an exploded perspective view showing a first polarizing plate shown in FIG. 2;

FIG. 4 is a cross-sectional view taken along a line I-I′ shown in FIG. 3;

FIG. 5 is an exploded perspective view showing a second polarizing member shown in FIG. 2;

FIG. 6 is a cross-sectional view showing the display panel shown in FIG. 2;

FIG. 7 is a cross-sectional view showing an absorption mode of first and second polarizing plates in the display panel shown in FIG. 6;

FIG. 8 is a perspective view showing a light passing through the first and second polarizing members in the absorption mode;

FIG. 9 is a cross-sectional view showing a reflective mode of first and second polarizing plates in the display panel shown in FIG. 6; and

FIG. 10 is a cross-sectional view showing a liquid crystal display according to another exemplary embodiment of the present disclosure.

### DETAILED DESCRIPTION

It will be understood that when an element or layer is referred to as being “on”, “connected to” or “coupled to” another element or layer, it can either be formed directly on, connected or coupled to the other element or layer or formed with intervening elements or layers. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, the described elements, components, regions, layers and/or sections are not limited by the terms used. The terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features may then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to limit the inventive concept. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Hereinafter, the inventive concept will be explained in detail with reference to the accompanying drawings.

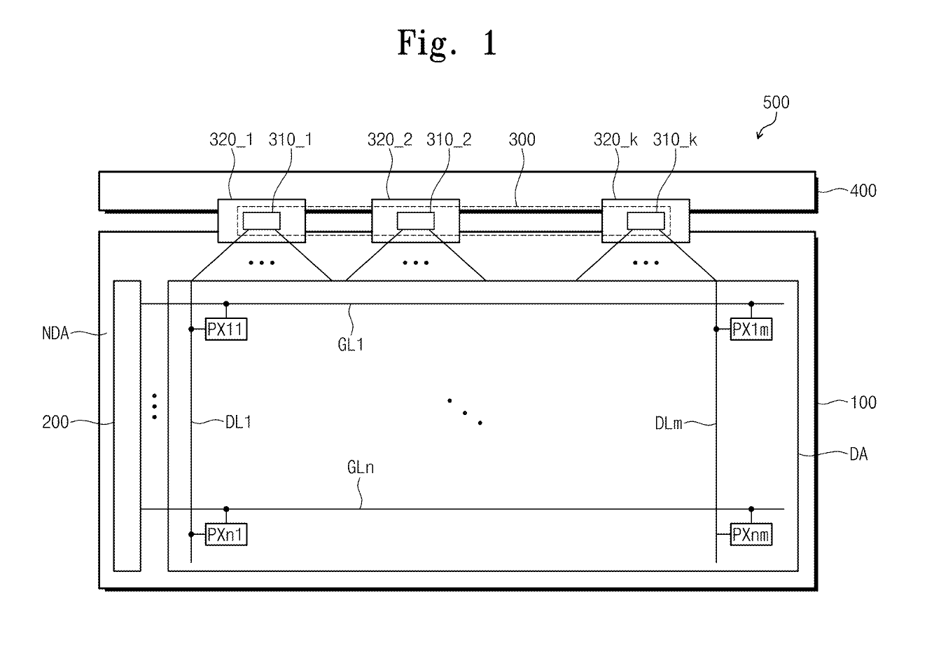

FIG. 1 is a plan view showing a liquid crystal display according to an exemplary embodiment of the present disclosure.

Referring to FIG. 1, the liquid crystal display 500 includes a display panel 100, a gate driver 200, a data driver 300, and a driving circuit board 400.

The display panel 100 includes a plurality of pixels PX11 to PXnm, a plurality of gate lines GL1 to GLn, and a plurality of data lines DL1 to DLm. Each of “m” and “n” is an integer number larger than zero (0). The display panel 100 includes a display area DA and a non-display area NDA surrounding the display area DA when viewed in a plan view.

The pixels PX11 to PXnm are disposed in the display area DA and arranged in a matrix form. The data lines DL1 to DLm are insulated from the gate lines GL1 to GLn and disposed to cross the gate lines GL1 to GLn, and the data lines DL1 to DLm are connected to the pixels PX11 to PXnm.

The gate lines GL1 to GLn extend in a row direction and are connected to the gate driver 200. The gate lines GL1 to GLn receive gate signals sequentially output from the gate driver 200.

The data lines DL1 to DLm extend in a column direction and are connected to the data driver 300. The data lines DL1 to DLm receive data voltages in analog form from the data driver 300.

Each of the pixels PX11 to PXnm is connected to a corresponding gate line of the gate lines GL1 to GLn and a corresponding data line of the data lines DL1 to DLm. The pixels PX11 to PXnm receive the data voltages through the data lines DL1 to DLm in response to the gate signals provided through the gate lines GL1 to GLn. The pixels PX11 to PXnm display gray scales corresponding to the data voltages.

The gate driver 200 is disposed in the non-display area NDA disposed adjacent to one side of the display area DA. In detail, the gate driver 200 may be mounted on the non-display area NDA adjacent to a left side of the display area DA in the form of amorphous silicon TFT gate driver circuit (ASG).

The gate driver 200 generates the gate signals in response to a gate control signal provided from a timing controller (not shown) mounted on the driving circuit board 400. The gate signals are sequentially applied to the pixels PX11 to PXnm through the gate lines GL1 to GLn row by row. As a result, the pixels PX11 to PXnm are driven in the unit of row.

The data driver 300 receives image signals and a data control signal from the timing controller. The data driver 300 generates the analog data voltages corresponding to the image signals in response to the data control signal. The data driver 300 applies the data voltages to the pixels PX11 to PXnm through the data lines DL1 to DLm.

The data driver 300 includes a plurality of source driving chips 310_1 to 310_{—}k. Here, “k” is an integer number larger than zero (0) and smaller than “k”. The source driving chips 310_1 to 310_{—}k are mounted on flexible printed circuit boards 320_1 to 320_{—}k, respectively, and connected between the driving circuit board 400 and the non-display area NDA adjacent to an upper side of the display area DA.

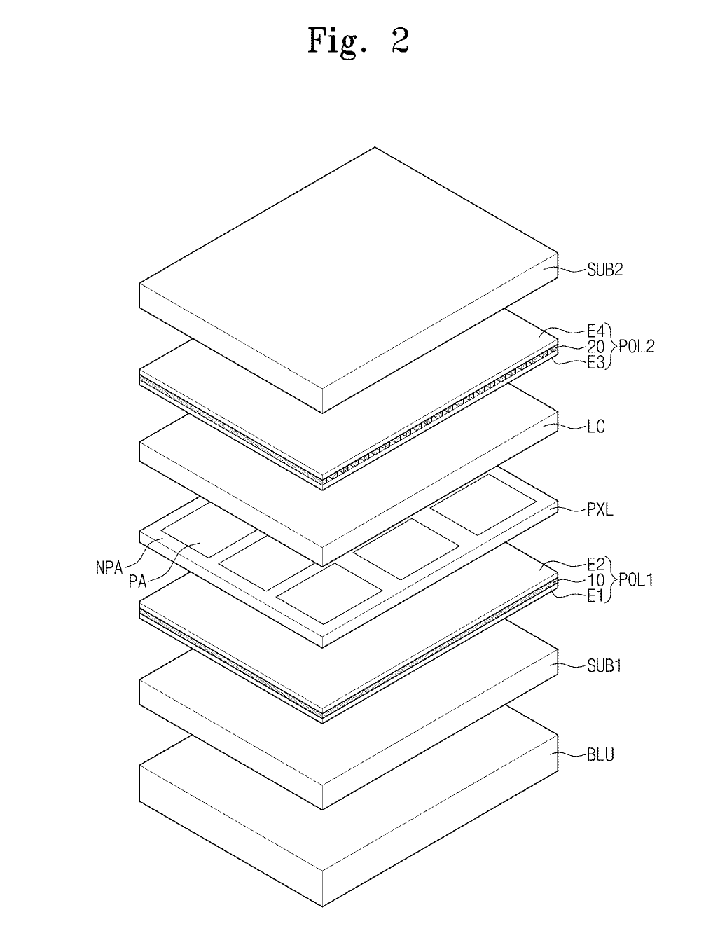

FIG. 2 is an exploded perspective view showing the display panel shown in FIG. 1.

Referring to FIG. 2, a backlight unit BLU is disposed under the display panel 100 to provide the light to the display panel 100.

The display panel 100 includes a first substrate SUB1, a first polarizing plate POL1, a pixel layer PXL, a liquid crystal layer LC, a second polarizing plate POL2, and a second substrate SUB2.

Each of the first and second substrates SUB1 and SUB2 may be a transparent or non-transparent insulating substrate. For instance, each of the first and second substrates SUB1 and SUB2 may be a silicon substrate, a glass substrate, or a plastic substrate having flexibility.

The first polarizing plate POL1 is disposed on the first substrate SUB1 and the pixel layer PXL is disposed on the first polarizing plate POL1. The second polarizing plate POL2 is disposed under the second substrate SUB2. The liquid crystal layer LC is disposed between the pixel layer PXL and the second polarizing plate POL2.

The first polarizing plate POL1 includes a first electrode E1, a second electrode E2, and a first polarizing member 10. The first polarizing member 10 is disposed between the first electrode E1 and the second electrode E2. In detail, the first polarizing member 10 is disposed on the first electrode E1 and the second electrode E2 is disposed on the first polarizing member 10.

The first and second electrodes E1 and E2 include a transparent conductive material, e.g., indium tin oxide, indium zinc oxide, indium tin zinc oxide, etc.

The first polarizing member 10 may be, but not limited to, an electrochromic material. The electrochromic material is a material having reversible optical property due to electrochemical oxidation and reduction reaction according to a voltage applied thereto. That is, the electrochromic material does not display color when no electric field is applied thereto and displays color when the electric field is applied thereto.

In the present exemplary embodiment, the first polarizing member 10, which is the electrochromic material, includes silver nitrate (AgNO3), copper chloride (CuCl2), tetra-n-butylammonium bromide (TBABr), and vynyl butyral (PVB).

The first polarizing member 10 absorbs the light or reflects the light. For example, the first polarizing member of silver nitrate (AgNO3) absorbs light and becomes black color, and reflects the light by the silver component therein according to the voltage applied thereto. In addition, the first polarizing member 10 has a transparent property to transmit the light when the electric field is not applied to the first polarizing member 10.

The first polarizing member 10 is operated in an absorption mode or a reflection mode in accordance with the voltages applied to the first and second electrodes E1 and E2. For instance, the first electrode E1 is applied with a first voltage and the second electrode E2 is applied with a second voltage.

The second voltage includes a positive second voltage and a negative second voltage. The positive second voltage has a level higher than that of the first voltage and the negative second voltage has a level lower than that of the first voltage.

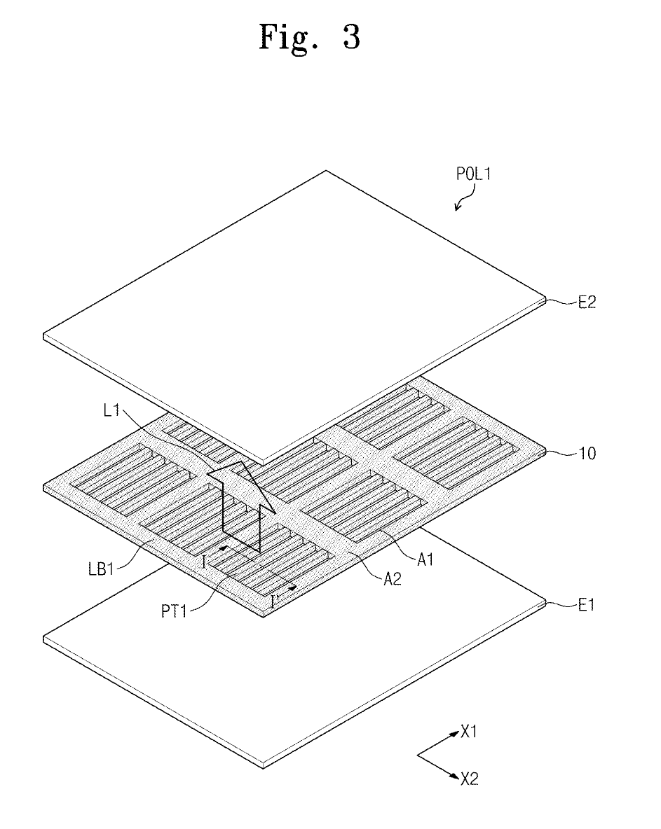

When the first voltage is applied to the first electrode E1 and the positive second voltage is applied to the second electrode E2, the first polarizing member 10 is operated in the absorption mode. When the first voltage is applied to the first electrode E1 and the negative second voltage is applied to the second electrode E2, the first polarizing member 10 is operated in the reflection mode. The operation of the first polarizing member 10 according to the absorption mode and the reflection mode will be described in detail with reference to FIG. 3.

The first and second electrodes E1 and E2 may be applied with the same voltage. In this case, the first polarizing member 10 is operated in a transmission mode to transmit the light.

The pixels PX11 to PXnm are disposed in the pixel layer PXL. In detail, each of the pixels PX11 to PXnm includes a thin film transistor and a pixel electrode connected to the thin film transistor. The pixel layer PXL includes pixel areas PA corresponding to the pixels PX11 to PXnm and a non-pixel area NPA disposed between the pixels PX11 to PXnm.

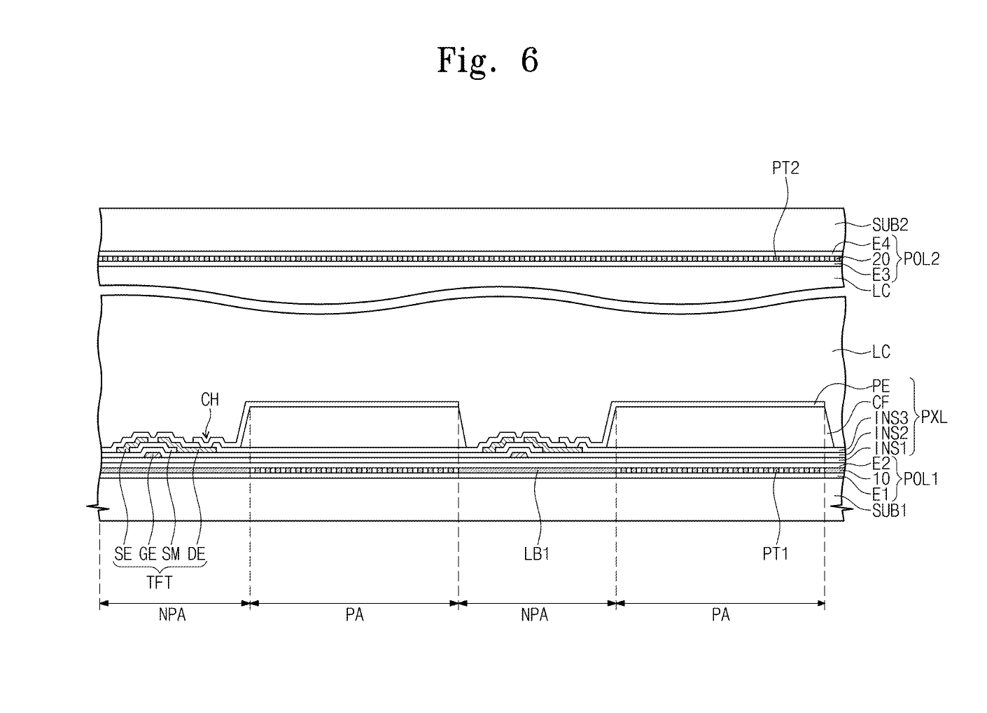

The pixel electrode is disposed in a corresponding pixel area PA. The thin film transistor is disposed in the non-pixel area NPA. The thin film transistor receives the data voltage through the corresponding data line in response to the gate signal provided through the corresponding gate line. The data voltage is applied to the pixel electrode. The configurations of the thin film transistor and the pixel electrode will be described in detail with reference to FIG. 6.

The second polarizing plate POL2 includes a third electrode E3, a fourth electrode E4, and a second polarizing member 20. The second polarizing member 20 is disposed between the third electrode E3 and the fourth electrode E4. In detail, the second polarizing member 200 is disposed on the fourth electrode E4 and the third electrode E3 serves as the common electrode.

The third and fourth electrodes E3 and E4 include a transparent conductive material, e.g., indium tin oxide, indium zinc oxide, indium tin zinc oxide, etc.

The second polarizing member 20 may be, but not limited to, the electrochromic material. Accordingly, the electrochromic material includes silver nitrate (AgNO3), copper chloride (CuCl2), tetra-n-butylammonium bromide (TBABr), and vynyl butyral (PVB).

The second polarizing member 20 is operated in the absorption mode in accordance with voltages applied to the third and fourth electrodes E3 and E4. For instance, the third electrode E3 is applied with a third voltage and the fourth electrode E4 is applied with a fourth voltage. The third voltage is the common voltage and the fourth voltage has a level higher than that of the third voltage.

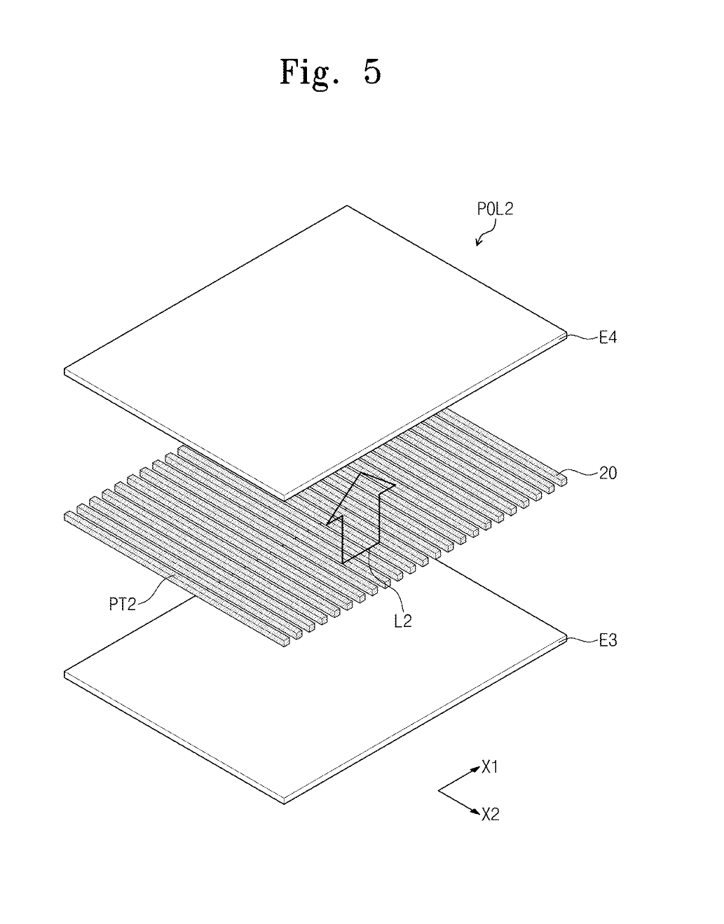

When the third voltage is applied to the third electrode E3 and the fourth voltage is applied to the fourth electrode E4, the second polarizing member 20 is operated in the absorption mode. The detailed description on the second polarizing member 20 will be described with reference to FIG. 5 later.

The third and fourth electrodes E3 and E4 may be applied with the same voltage. In this case, the second polarizing member 20 is operated in a transmission mode to transmit the light.

When the third voltage is applied to the third electrode E3 and a voltage having the level lower than that of the third voltage is applied to the fourth electrode E4, the second polarizing member 20 is operated in the reflection mode.

In the present exemplary embodiment, since the second polarizing member 20 is operated in the absorption mode, description on the reflection mode of the second polarizing member 20 will be omitted.

The liquid crystal molecules of the liquid crystal layer LC are driven by the pixels PX11 to PXnm. In detail, the liquid crystal molecules of the liquid crystal layer LC are driven by the data voltage applied to the pixel electrode and the third voltage applied to the third electrode E3 of the second polarizing plate POL2.

The third voltage is a reference voltage with a constant voltage level and the data voltages are variable with respect to the reference voltage, and thus the liquid crystal molecules of the liquid crystal layer LC are driven. That is, the liquid crystal molecules of the liquid crystal layer LC are driven by the data voltages applied to the pixels PX11 to PXnm.

The light provided from the backlight unit BLU travels to the first polarizing plate POL1. A portion of the first polarizing plate POL1, which corresponds to the non-pixel area NPA, absorbs or reflects the light from the backlight unit BLU to block the light. The other portion of the first polarizing plate POL1, which corresponds to the pixel area PA, polarizes the light from the backlight unit BLU.

In detail, the first polarizing member 10 is operated in the absorption mode or the reflection mode by the first and second voltages respectively applied to the first and second electrodes E1 and E2. The first polarizing member 10 operated in the absorption mode or the reflection mode absorbs or reflects the light from the backlight unit BLU in the portion corresponding to the non-pixel area NPA.

In addition, the first polarizing member 10 operated in the absorption mode or the reflection mode polarizes the light from the backlight unit BLU in the portion corresponding to the pixel area PA. Hereinafter, the light polarized by the first polarizing member 10 of the first polarizing plate POL1 is referred to as a first polarized light.

The first polarized light by the first polarizing plate POL1 is provided to the pixel area PA of the pixel layer PXL. The liquid crystal molecules of the liquid crystal layer LC driven by the pixels PX11 to PXnm of the pixel layer PXL rotate a polarizing axis of the first polarized light.

In more detail, the polarizing axis of the first polarized light is rotated by the liquid crystal molecules driven by the data voltage and the third voltage and the first polarized light is converted to a second polarized light to transmit through the second polarizing plate POL2. The polarizing axis of the first polarized light may be substantially vertical to a polarizing axis of the second polarized light. That is, the liquid crystal molecules rotate the polarizing axis of the first polarized light to convert the first polarized light to the second polarized light having the polarizing axis substantially vertical to the polarizing axis of the first polarized light.

The second polarizing plate POL2 transmits the second polarized light. The second polarizing member 20 is operated in the absorption mode by the third and fourth voltages respectively applied to the third and fourth electrodes E3 and E4. The second polarizing member 20 operated in the absorption mode transmits the second polarized light. Therefore, the second polarized light transmitting through the second polarizing plate POL2 is provided to a user.

Hereinafter, the operation of the first and second polarizing plates POL1 and POL2 according to the application of the voltages will be described in detail.

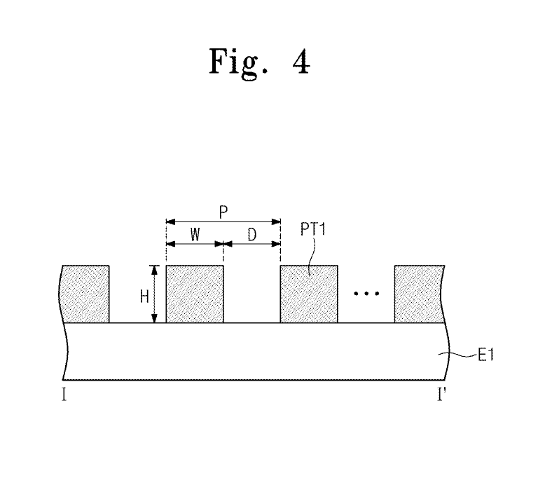

FIG. 3 is an exploded perspective view showing the first polarizing plate shown in FIG. 2 and FIG. 4 is a cross-sectional view taken along a line I-I′ shown in FIG. 3.

For the convenience of explanation, FIG. 4 shows only the first electrode E1 and the first polarizing member 10 disposed on the first electrode E1.

Referring to FIGS. 3 and 4, the first polarizing member 10 includes a plurality of first areas A1 corresponding to the pixel areas PA and a second area A2 corresponding to the non-pixel area NPA. That is, the first polarizing member 10 includes the first areas A1 and the second area A2 disposed adjacent to the first areas A1 when viewed in a plan view.

The light provided from the backlight unit BLU is polarized by the first polarizing member 10 in the first areas A1 and provided the first polarized light L1 to the pixel areas PA of the pixel layer PXL. The light provided from the backlight unit BLU is blocked by the first polarizing member 10 in the second area A2.

Although not shown in figures, the first polarizing plate POL1 may include the first areas A1 and the second area A2 disposed adjacent to the first areas A1 which correspond to the first area A1 and the second area A2 of the first polarizing member 10. Thus, the light provided from the backlight unit BLU is polarized in the first areas A1 of the first polarizing plate POL1 and provided to the pixel areas PA as the first polarized light L1, and the light provide from the backlight unit BLU is blocked by the first polarizing plate POL1 in the second area A2.

The first polarizing member 10 includes a plurality of first polarizing patterns PT1 disposed in the first areas A1 and a first light blocking member LB1 disposed in the second area A2. The first polarizing patterns PT1 and the first light blocking member LB1 are formed of the same material. The first polarizing patterns PT1 and the first light blocking member LB1 include silver nitrate (AgNO3), copper chloride (CuCl2), tetra-n-butylammonium bromide (TBABr), and vynyl butyral (PVB).

The first polarizing patterns PT1 are disposed to be spaced apart from each other at regular intervals and extend in a first direction X1. The first polarizing patterns PT1 have a pitch P that includes a width W and a distance D. The first polarizing patterns PT1 have substantially the same height H and the same width W. The width W of each of the first polarizing patterns PT1 is equal to a distance D between the first polarizing patterns PT1.

As described above, when the first voltage is applied to the first electrode E1 and the second voltage is applied to the second electrode E2, the first polarizing member 10 is operated in the absorption mode or the reflection mode. When the pitch P of the first polarizing patterns PT1 is smaller than a wavelength of the light, the polarized light substantially vertical to the first polarizing patterns PT1 transmits through the first polarizing patterns PT1 and the polarized light substantially in parallel to the first polarizing patterns PT1 is absorbed or reflected by the first polarizing patterns PT1.

That is, among the light traveling to the first polarizing patterns PT1, the polarized light substantially vertical to the first direction X1 in which the first polarizing patterns PT1 extend transmits through the first polarizing patterns PT1 and the polarized light substantially in parallel to the first direction X1 is absorbed or reflected by the first polarizing patterns PT1.

The above-mentioned first polarized light L1 corresponds to the light transmitting through the first polarizing patterns PT1. The light transmitting through the first polarizing patterns PT1 corresponds to the first polarized light L1, which is the polarized light substantially vertical to the first direction X1.

The light generated from the backlight unit BLU is a visible light having a wavelength of about 400 nm to about 700 nm. The pitch P of the first polarizing patterns PT1 may correspond to a half of the wavelength of the visible light incident to the first polarizing patterns PT1.

For instance, the first polarizing patterns PT1 have the pitch P of about 100 nm to about 200 nm. In this case, each of the first polarizing patterns PT1 has the width W of about 50 nm to about 100 nm. In addition, each of the first polarizing patterns PT1 has the height H of about 50 nm to about 100 nm. That is, each of the first polarizing patterns PT1 has a thickness of about 50 nm to about 100 nm.

A sum of the thickness of the first and second electrodes E1 and E2 and the height of the first polarizing patterns PT1 becomes about 2.3 micrometers. That is, the first polarizing plate POL1 has a thickness of about 2.3 micrometers. The first light blocking member LB1 has the same thickness as that of the first polarizing patterns PT1.

When the first polarizing member 10 is operated in the absorption or reflection mode, the first light blocking member LB1 absorbs or reflects the light provided from the backlight unit BLU to block the light from the backlight unit BLU.

FIG. 5 is an exploded perspective view showing the second polarizing member shown in FIG. 2.

Referring to FIG. 5, the second polarizing member 20 includes a plurality of second polarizing patterns PT2 arranged to be spaced apart from each other at regular intervals and extending in a second direction X2. That is, the second polarizing patterns PT2 are disposed to be substantially vertical to the first polarizing patterns PT1.

The second polarizing patterns PT2 are formed of the same material as the first polarizing patterns PT1. In addition, the second polarizing patterns PT2 have the same pitch, height, and width as those of the first polarizing patterns PT1.

A sum of the thickness of the third and fourth electrodes E3 and E4 and the height of the second polarizing patterns PT2 becomes about 2.3 micrometers. That is, the second polarizing plate POL2 has a thickness of about 2.3 micrometers.

As described above, when the third voltage is applied to the third electrode E3 and the fourth voltage is applied to the fourth electrode E4, the second polarizing member 20 is operated in the absorption mode. Accordingly, the polarized light substantially vertical to the second polarizing patterns PT2 transmits through the second polarizing patterns PT2 and the polarized light substantially in parallel to the second polarizing patterns PT2 is absorbed by the second polarizing pattern PT2.

When the liquid crystal molecules of the liquid crystal layer LC are driven, the liquid crystal molecules rotate the polarizing axis of the first polarized light L1 to convert the first polarized light L1 to the second polarized light L2 having the polarizing axis substantially vertical to the polarizing axis of the first polarized light L1.

The second polarized light L2 is substantially vertical to the second polarizing patterns PT2. That is, the polarizing axis of the second polarized light L2 is substantially vertical to the second direction X2 in which the second polarizing patterns PT2 extend. Therefore, the second polarized light L2 may transmit through the second polarizing patterns PT2.

In a conventional liquid crystal display, the polarizing plates are disposed under the first substrate SUB1 and on the second substrate SUB2, respectively. To attach the polarizing plates to the first and second substrates SUB1 and SUB2, a polymer-type polarizer is used.

The polymer-type polarizer has a thickness of about 200 micrometers to about 250 micrometers. The polymer-type polarizer is manufactured by a separate process from the manufacturing method of the liquid crystal display, and then attached to the display panel.

In the liquid crystal display 500 according to the present exemplary embodiment, however, the first polarizing plate POL1 is disposed on the first substrate SUB1 and the second polarizing plate POL2 is disposed under the second substrate SUB2. That is, the first and second polarizing plates POL1 and POL2 may be manufactured together with the liquid crystal display 500 without being separately manufactured when the liquid crystal display 500 is manufactured.

The first and second polarizing plates POL1 and POL2 have the thickness of about 2.3 micrometers. Since the first and second polarizing plates POL1 and POL2 have the thickness smaller than that of the polymer-type polarizer, the thickness of the liquid crystal display 500 may be reduced.

FIG. 6 is a cross-sectional view showing the display panel shown in FIG. 2.

For the convenience of explanation, FIG. 6 shows the cross-sectional view of the first polarizing member 10 in the second direction X2, the cross-sectional view of the second polarizing member 20 in the first direction X1, and the cross-sectional view corresponding to the first polarizing member 10.

In addition, FIG. 6 shows two pixel areas PA and the non-pixel area NPA disposed between the two pixel areas PA, but other pixel areas PA and the non-pixel area NPA have the same structures as those of the pixel areas PA and the non-pixel are NPA shown in FIG. 6.

Referring to FIG. 6, the first polarizing plate POL1 is disposed on the first substrate SUB1. As described above, the first polarizing patterns PT1 of the first polarizing member 10 are disposed in the pixel areas PA and the first light blocking member LB1 is disposed in the non-pixel area NPA.

The pixel layer PXL is disposed on the first polarizing plate POL1. The pixel layer PXL includes the thin film transistor TFT disposed in the non-pixel area NPA and the color filters CF and the pixel electrodes PE, which are disposed in the pixel areas PA.

In detail, a first insulating layer INS1 is disposed on the first polarizing plate POL1. The first insulating layer INS1 may be an inorganic insulating layer formed of an inorganic material. For instance, the first insulating layer INS1 may include an inorganic insulating material, e.g., silicon nitride, silicon oxide, etc.

The thin film transistor TFT is disposed on the first insulating layer INS1. The thin film transistor TFT includes a gate electrode, a semiconductor layer SM, a source electrode SE, and a drain electrode DE.

The gate electrode GE is disposed on the first insulating layer INS1. Although not shown in figures, the gate electrode GE is branched from the corresponding gate line. A second insulating layer INS2 is disposed on the first insulating layer INS1 to cover the gate electrode GE. The second insulating layer INS2 may be an inorganic insulating layer formed of an inorganic material.

The semiconductor layer SM of the thin film transistor TFT is disposed on the second insulating layer INS2 that covers the gate electrode GE. Although not shown in figures, the semiconductor layer SM may includes an active layer and an ohmic contact layer.

The source electrode SE and the drain electrode DE of the thin film transistor TFT are disposed on the semiconductor layer SM and the second insulating layer INS2 and spaced apart from each other. Although not shown in figures, the source electrode SE is branched from the corresponding data line. The semiconductor layer SM forms a conductive channel between the source electrode SE and the drain electrode DE.

A third insulating layer INS3 is disposed on the second insulating layer INS2 to cover the thin film transistor TFT. The third insulating layer INS3 may be a passivation layer. The third insulating layer INS3 may be an inorganic insulating layer formed of an inorganic material. The third insulating layer INS3 covers the exposed upper portion of the semiconductor layer SM.

The third insulating layer INS3 is provided with a contact hole CH formed therethrough to expose a predetermined area of the drain electrode DE. The pixel electrode PE disposed in the pixel area PA extends and is electrically connected to the drain electrode DE of the thin film transistor TFT through the contact hole CH.

The color filter CF is disposed on the third insulating layer INS3 in the pixel area PA. The color filter CF assigns a color to the light transmitting through the pixel area PA. The color filter CF is a red color filter, a green color filter, or a blue color filter and disposed to correspond to the pixel area PA.

The second polarizing plate POL2 is disposed under the second substrate SUB2. The configuration of the second polarizing plate POL2 is the same as the above-mentioned description.

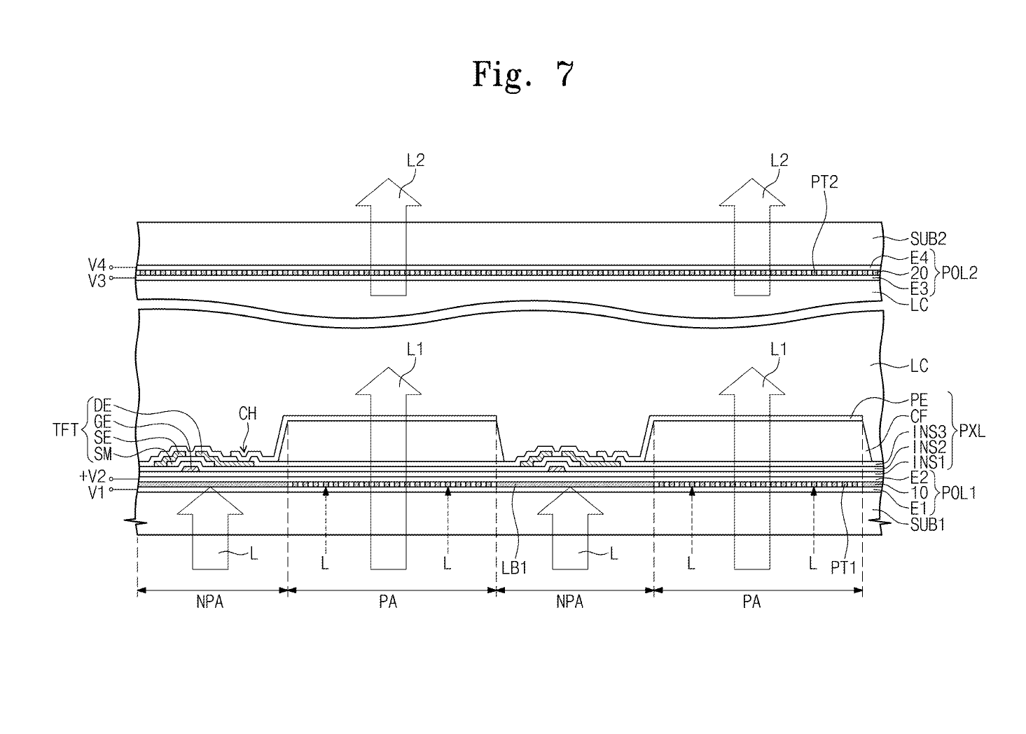

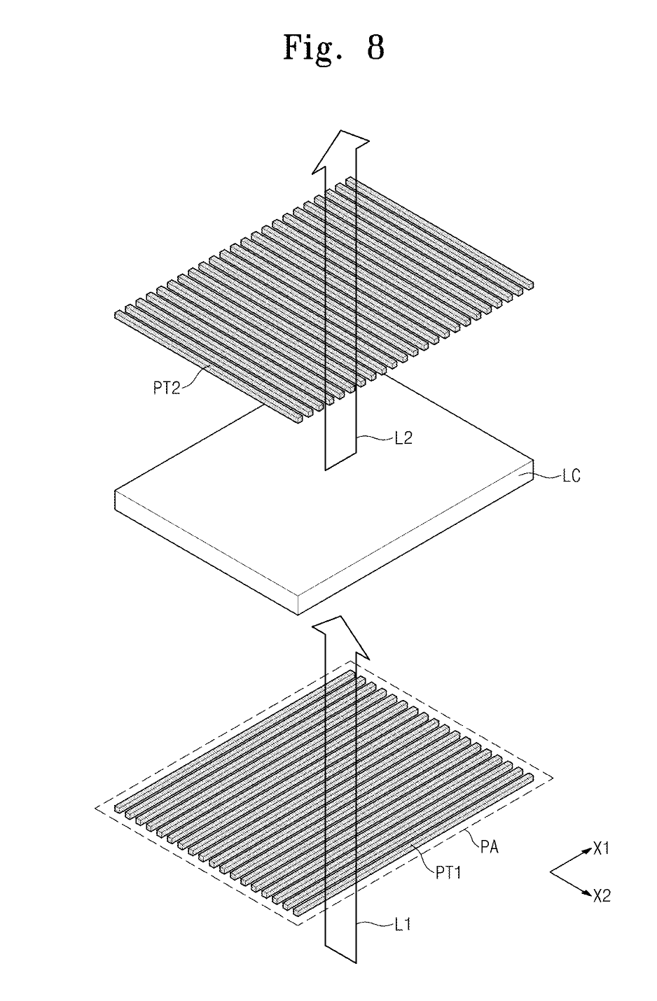

FIG. 7 is a cross-sectional view showing the absorption mode of the first and second polarizing plates in the display panel shown in FIG. 6 and FIG. 8 is a perspective view showing the light passing through the first and second polarizing members in the absorption mode.

For the convenience of explanation, FIG. 8 shows the light passing through the first polarizing patterns PT1 and the second polarizing patterns PT2 in the pixel area PA.

Referring to FIGS. 7 and 8, the first voltage V1 is applied to the first electrode E1 and the positive second voltage +V2 is applied to the second electrode E2. The third voltage V3 is applied to the third electrode E3 and the fourth voltage V4 having the level higher than that of the third voltage V3 is applied to the fourth electrode E4.

The light L generated by the backlight unit BLU is provided to the first polarizing plate POL1. Among the light L provided from the backlight unit BLU, the first polarizing patterns PT1 of the first polarizing plate POL1 transmit the polarized light substantially vertical to the first direction X1 and absorb the polarized light substantially in parallel to the first direction X1. The first polarized light L1 polarized by the first polarizing patterns PT1 is provided to the liquid crystal layer LC in the pixel area PA.

The first light blocking member LB1 absorbs the light L provided from the backlight unit BLU to block the light L from entering into the non-pixel area NPA. Therefore, the non-pixel area NPA is displayed in the black color. As a result, the light L is not provided to the liquid crystal layer LC in the non-pixel area NPA.

The thin film transistor TFT is turned on in response to the gate signal. The turned-on thin film transistor TFT receives the data voltage. The data voltage is applied to the pixel electrode PE through the turned-on thin film transistor TFT.

Due to the data voltage applied to the pixel electrode PE and the third voltage V3 applied to the third electrode E3, the electric field is formed between the pixel electrode PE and the third electrode E3. The liquid crystal molecules of the liquid crystal layer LC are driven by the electric field formed between the third electrode E3 applied with the third voltage V3 and the pixel electrode PE applied with the data voltage.

When the liquid crystal molecules are driven, the liquid crystal molecules rotate the polarizing axis of the first polarized light L1 to convert the first polarized light L1 to the second polarized light L2 having the polarizing axis substantially vertical to the polarizing axis of the first polarized light L1. The polarizing axis of the second polarized light L2 is substantially vertical to the second direction X2. Thus, the second polarized light L2 transmits through the second polarizing patterns PT2 and is provided to the user.

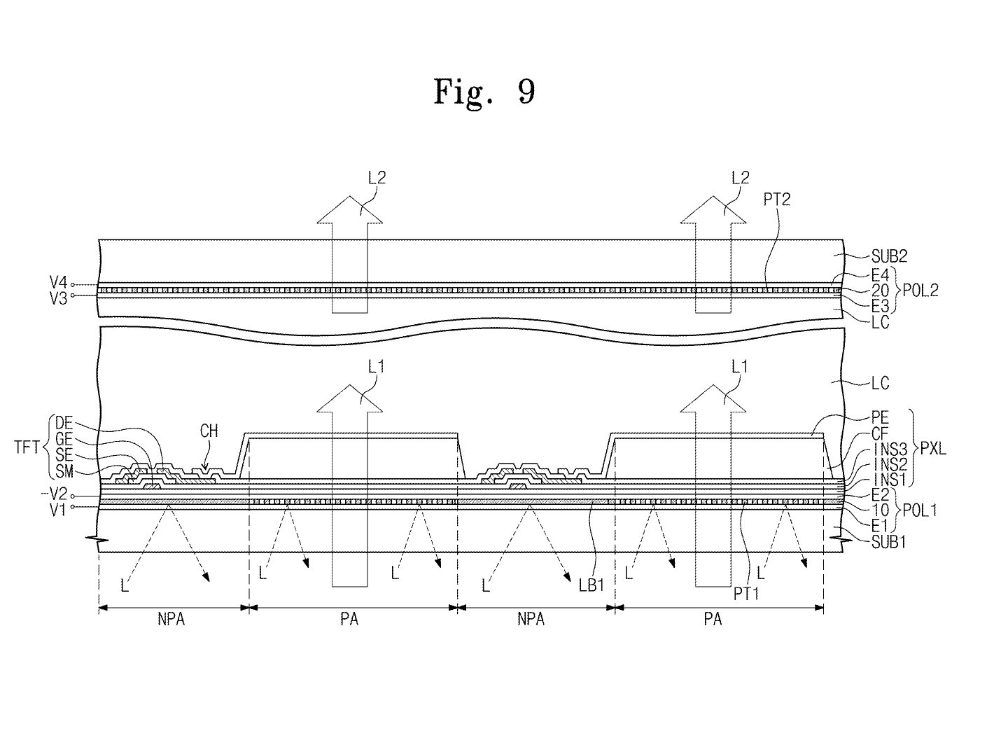

FIG. 9 is a cross-sectional view showing the reflection mode of the first and second polarizing plates in the display panel shown in FIG. 6.

In the reflection mode, the light transmitting through the first and second polarizing members 10 and 20 is substantially the same as the light shown in FIG. 8. Accordingly, the light transmitting through the first and second polarizing members 10 and 20 is not shown.

Referring to FIG. 9, the first voltage V1 is applied to the first electrode E1 and the negative second voltage −V2 is applied to the second electrode E2. The third voltage V3 is applied to the third electrode E3 and the fourth voltage V4 is applied to the fourth electrode E4.

The light generated by the backlight unit BLU is provided to the first polarizing plate POL1. Among the light from the backlight unit BLU, the first polarizing patterns PT1 of the first polarizing plate POL1 transmit the polarized light substantially vertical to the first direction X1 and reflect the polarized light substantially in parallel to the first direction X1. The first polarized light L1 polarized by the first polarizing patterns PT1 is provided to the liquid crystal layer LC in the pixel area PA.

The first light blocking member LB1 reflects the light provided from the backlight unit BLU to block the light from entering into the non-pixel area NPA. Thus, the light is not provided to the liquid crystal layer LC in the non-pixel area NPA.

Although not shown in figures, a retardation film having λ/4 retardation may be disposed under the second polarizing plate POL2. An external light may be provided to the display panel 100 from the above of the display panel 100. The external light is polarized by the second polarizing plate POL2. That is, the second polarizing patterns PT2 of the second polarizing plate POL2 transmit the polarized light substantially vertical to the second direction X2 among the external light.

An optical axis of the polarized external light is twisted by the retardation film. The external light having the optical axis twisted by the retardation film may be reflected by the first light blocking member LB1 of the display panel 100. The optical axis of the reflected external light is twisted again by the retardation film.

The external light having the optical axis twisted again by the retardation film may be substantially in parallel to the second direction X2. Thus, the external light reflected by the metal layers and the first light blocking member LB1 inside the display panel 100 does not transmit through the second polarizing patterns PT2 of the second polarizing plate POL2 and are absorbed by the second polarizing patterns PT2. Accordingly, the external light reflected by the first light blocking member LB1 is not provided to the user.

The first light blocking member LB1 reflects the light provided from the backlight unit BLU to block the light. In addition, the external light reflected by the first light blocking member LB1 is not provided to the user. Therefore, the non-pixel area NPA in which the first light blocking member LB1 is disposed is not recognized by the user and is displayed in the black color.

The light L reflected by the first light blocking member LB1 is provided to the backlight unit BLU. Although not shown in figures, the backlight unit BLU includes a reflective plate. The light reflected by the first light blocking member LB1 is reflected again by the reflective plate of the backlight unit BLU, and then provided to the display panel 100. Thus, the light L reflected by the first light blocking member LB1 may be recycled to save power for image display.

The data voltage is applied to the pixel electrode PE by the thin film transistor TFT. The liquid crystal molecules are driven by the data voltage and the third voltage V3. The liquid crystal molecules rotate the polarizing axis of the polarized light L1 to convert the first polarized light L1 to the second polarized light L2 having the polarizing axis substantially vertical to the polarizing axis of the first polarizing light L1. The second polarized light L2 transmits through the second polarizing patterns PT2 and is provided to the user.

In the conventional liquid crystal display, a black matrix is used to block the light in the non-pixel area NPA. In this case, an ionic material generated from the black matrix may move to the liquid crystal layer LC by the electric field formed between the pixel electrode PE and the common electrode E3. The ionic material may disturb the movement of the liquid crystal molecules of the liquid crystal layer LC.

Accordingly, although the data voltage and the common voltage area respectively applied to the pixel electrode PE and the common electrode E3, the liquid crystal molecules may not be driven properly due to the ionic material. In this case, an image of a previous frame remains as an afterimage, and thus reliability of the liquid crystal display is lowered.

However, the liquid crystal display 500 includes the first polarizing member 10 to block the light in the non-pixel area NPA. The first light blocking member LB1 of the first polarizing member 10 blocks the light in the non-pixel area NPA.

Since the liquid crystal display 500 does not include the black matrix, the ionic material is not generated. Therefore, the liquid crystal molecules are driven properly, and thus the afterimage may not be generated. As a result, the reliability of the liquid crystal display 500 may be improved.

In addition, as described above, the first and second polarizing plates POL1 and POL2 have the thickness smaller than that of the polymer-type polarizer and the thickness of the liquid crystal display 500 is reduced.

Consequently, the thickness of the liquid crystal display 500 is reduced and the reliability of the liquid crystal display 500 is improved.

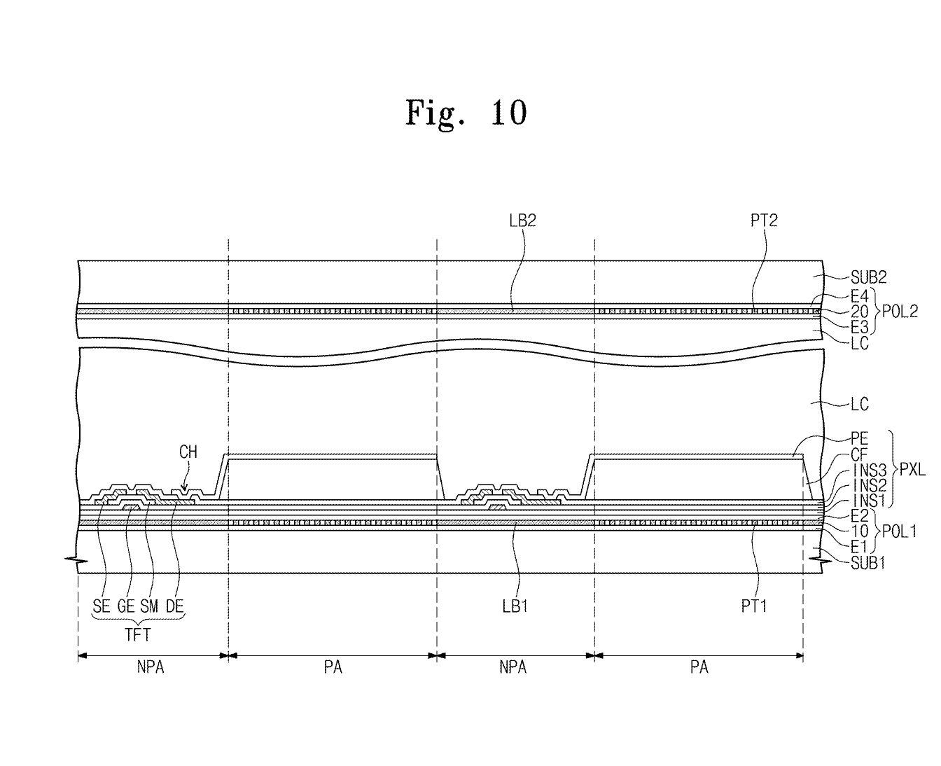

FIG. 10 is a cross-sectional view showing a liquid crystal display according to another exemplary embodiment of the present disclosure.

The liquid crystal display shown in FIG. 10 have the same structure and function as those of the liquid crystal display 500 shown in FIG. 1 except for the second polarizing plate POL2. Accordingly, only description on the second polarizing plate POL2 will be described in detail.

Referring to FIG. 10, a second polarizing plate POL2 includes second polarizing patterns PT2 disposed in areas corresponding to the pixel areas PA and a second light blocking member LB2 disposed in an area corresponding to the non-pixel area NPA. The second polarizing patterns PT2 extend in the second direction X2 and are spaced apart from each other at regular intervals. That is, the second polarizing patterns PT2 extend in a direction substantially vertical to the polarizing axis of the second polarized light L2.

The third voltage V3 is applied to the third electrode E3 and the fourth voltage V4 having the level higher than that of the third voltage V3 is applied to the fourth electrode E4.

The liquid crystal molecules are driven by the data voltage and the third voltage V3. The liquid crystal molecules rotate the polarizing axis of the first polarized light L1 to convert the first polarized light L1 to the second polarized light L2 having the polarizing axis substantially vertical to the polarized axis of the first polarized light L1. The second polarized light L2 transmits through the second polarizing patterns PT2 in the pixel areas PA, and then provided to the user.

The second light blocking member LB2 absorbs the external light in the non-pixel area NPA to block the external light. In addition, the light provided from the backlight unit BLU in the non-pixel area NPA may be blocked by the first and second light blocking members LB1 and LB2. Thus, the light is not recognized by the user in the non-pixel area NPA and the non-pixel area NPA is displayed in the black color.

In the liquid crystal display 500 according to another exemplary embodiment, the first and second polarizing members 10 and 20 are used to block the light in the non-pixel area NPA without using the black matrix. Therefore, since the ionic material is not generated, the liquid crystal molecules are driven properly and the no afterimage is generated. In addition, as described above, the first and second polarizing plates POL1 and POL2 have the thickness smaller than that of the polymer-type polarizer.

Consequently, the thickness of the liquid crystal display is reduced and the reliability of the liquid crystal display is improved.

Although the exemplary embodiments of the present inventive concept have been described, it is understood that the present inventive concept should not be limited to these exemplary embodiments but various changes and modifications can be made by one ordinary skilled in the art within the spirit and scope of the present inventive concept as hereinafter claimed.

What is claimed is:

1. A liquid crystal display comprising:
a first polarizing plate that includes a plurality of first areas to polarize a light and a second area disposed between the first areas to block the light;
a pixel layer that includes a plurality of pixels and receives a first polarized light;
a liquid crystal layer driven by the plurality of pixels and rotating a polarizing axis of the first polarized light to convert the first polarized light to a second polarized light having a polarizing axis substantially vertical to the polarizing axis of the first polarized light; and
a second polarizing plate that transmits the second polarized light.

2. The liquid crystal display of claim 1, wherein the pixel layer comprises:
a plurality of pixel areas corresponding to the first areas to receive the first polarized light; and
a non-pixel area disposed between the pixel areas to correspond to the second area.

3. The liquid crystal display of claim 2, wherein the first polarizing plate comprises:
a first electrode applied with a first voltage;
a first polarizing member disposed on the first electrode; and
a second electrode disposed on the first polarizing member to receive a second voltage, the light is polarized by the first polarizing member in the first areas and provided to the pixel areas as the first polarized light, and the light is blocked by the first polarizing member in the second area.

4. The liquid crystal display of claim 3, wherein the first polarizing member comprises:
a plurality of first polarizing patterns disposed in the first areas and extending in a first direction; and
a first light absorbing member disposed in the second area,
wherein the plurality of first polarizing patterns transmit the light substantially vertical to the first direction among the light as the first polarized light, and the first light absorbing member blocks the light.

5. The liquid crystal display of claim 4, wherein the second voltage comprises:
a positive second voltage having a level higher than a level of the first voltage; and
a negative second voltage having a level lower than the level of the first voltage.

6. The liquid crystal display of claim 5, wherein the second electrode receives the positive second voltage and the first light absorbing member absorbs the light.

7. The liquid crystal display of claim 5, wherein the second electrode receives the negative second voltage and the first light absorbing member reflects the light.

8. The liquid crystal display of claim 3, wherein the second polarizing plate comprises:
a third electrode applied with a third voltage;
a second polarizing member disposed on the third electrode to transmit the second polarized light; and
a fourth electrode disposed on the second polarizing member to receive a fourth voltage having a level higher than a level of the third voltage.

9. The liquid crystal display of claim 8, wherein the first polarizing member and the second polarizing member comprise silver nitrate (AgNO3), copper chloride (CuCl2), tetra-n-butylammonium bromide (TBABr), and vynyl butyral (PVB).

10. The liquid crystal display of claim 8, wherein the second polarizing member comprises a plurality of second polarizing patterns extending in a direction substantially vertical to the polarizing axis of the second polarized light and the second polarizing patterns transmit the second polarized light.

11. The liquid crystal display of claim 10, wherein a pitch of the second polarizing pattern is from about 100 nm to about 200 nm.

12. The liquid crystal display of claim 11, wherein the second polarizing patterns has a width from about 50 nm to about 100 nm and a thickness from about 50 nm to about 100 nm.

13. The liquid crystal display of claim 3, wherein the second polarizing plate comprises:
a third electrode applied with a third voltage;
a second polarizing member disposed on the third electrode; and
a fourth electrode disposed on the second polarizing member to receive a fourth voltage having a level higher than a level of the third voltage, and the second polarizing member transmits the second polarized light in areas corresponding to the pixel areas and reflects the light and an external light in an area corresponding to the non-pixel area.

14. The liquid crystal display of claim 13, wherein the second polarizing member comprises:
a plurality of second polarizing patterns disposed in the areas corresponding to the pixel areas and extending in a direction substantially vertical to the polarizing axis of the second polarized light; and
a second light absorbing member disposed in the area corresponding to the non-pixel area, the second polarizing patterns transmit the second polarized light and the second light absorbing member blocks the light and the external light.

15. The liquid crystal display of claim 1, further comprising:
first and second substrates facing each other; and
a backlight unit disposed under the first substrate to provide the light to the first polarizing plate, wherein the first polarizing plate is disposed on the first substrate and the second polarizing plate is disposed under the second substrate.

16. The liquid crystal display of claim 1, wherein each of the first and second polarizing plates has a thickness of about 2.3 micrometers.

17. A liquid crystal display comprising:
a first polarizing plate that includes a plurality of first areas to polarize a light and a second area disposed between the first areas to block the light, the first area including a first polarizing patterns extending along a first direction;
a pixel layer that includes a plurality of pixels and receives a first polarized light;
a liquid crystal layer driven by the plurality of pixels and rotating a polarizing axis of the first polarized light to convert the first polarized light to a second polarized light having a polarizing axis substantially vertical to the polarizing axis of the first polarized light; and
a second polarizing plate that transmits the second polarized light, the second polarizing plate including a second polarizing patterns extending along a second direction substantially perpendicular to the first direction.

18. The liquid crystal display of claim 17, wherein the first polarizing plate is disposed on a first substrate and the second polarizing plate is disposed on a second substrate facing the first substrate,
wherein each of the first polarizing plate and the second polarizing plate includes a first electrode, a second electrode and an electrochromic material disposed between the first electrode and the second electrode.

19. The liquid crystal display of claim 18, wherein the first polarizing plate is disposed between a color filter layer and a pixel electrode.

20. The liquid crystal display of claim 19, wherein the first polarizing patterns and the second polarizing patterns have a width and a height, and
wherein the height is greater than the width.
